(19) United States
(12) Patent Application Publication
(10) Pub. No.: US 2018/0105345 A1
(43) Pub. Date: Apr. 19, 2018

(54) Polarizing Material Bag

(71) Applicants: Nicholas E. Frisard, Metairie, LA (US); Daniel DeVun, JR., Metairie, LA (US)

(72) Inventors: Nicholas E. Frisard, Metairie, LA (US); Daniel DeVun, JR., Metairie, LA (US)

(21) Appl. No.: 15/430,287

(22) Filed: Feb. 10, 2017

Related U.S. Application Data
(60) Provisional application No. 62/409,195, filed on Oct. 17, 2016.

(51) Int. Cl. B65D 81/30; G02B 5/30; A45C 1/02; A45C 13/10; A45C 5/03; A45C 11/00; A45C 11/08; A45C 11/38; A45F 3/04

(52) U.S. Cl. CPC B65D 81/30; G02B 5/30; A45C 1/02; A45C 13/10; A45C 2011/003; A45C 11/00; A45C 11/08; A45C 11/38; A45F 3/04; A45C 5/03

(57) ABSTRACT

The present invention relates to an improved bag design comprised of polarizing materials.

### CROSS REFERENCE TO RELATED APPLICATION

This application claims priority from U.S. Provisional Application No. 62/409,195 (Frisard) filed on Oct. 17, 2016, which is incorporated herein by reference as if set forth in full below.

### BACKGROUND OF THE INVENTION

### I. Field of the Invention

The present invention relates generally to a bag (or any item carrying container) comprised at least partially of polarizing material.

### II. General Background

The National Football League® and other professional organizations have recently adopted a “clear purse” policy. These “clear purse” policies are allegedly adopted to enhance public safety and improve efficiencies in entering event venues by allowing attendees to move through security check points faster, and by enabling event staff to be more consistent, efficient and effective in checking bags that are brought into an event venue.

Such “clear purse” policies generally allow only clear purses of a certain size to be permitted into venues or event spaces. Additionally, attendees are generally not allowed to put non-clear bags into a clear purse. As such, the contents of an attendees' purse are viewable to the public, including items considered valuable (and therefore susceptible to theft) or items that are considered personal or private. These “clear purse” policies apply not only to purses, but all bags, luggage, diaper bags, camera cases, binocular cases, etc.

In view of the foregoing, there is, in our view, a continuing need for a bag, purse, suitcase, backpack, luggage, diaper bags, computer bags, tablet cases, document folders, camera bags, binocular cases, or any item carrying container that is made of a clear or translucent material (thereby meeting the requirements of the “clear purse” policy), but can also reduce or completely obstruct the ability to view the contents of the purse when not being inspected.

### SUMMARY OF THE INVENTION

In accordance with one embodiment, the present invention is a bag comprising a first face comprising polarizing material having a first polarizing axis and a second face comprising polarizing material having a second polarizing axis, wherein said first polarizing axis and said second polarizing axis are at a 90 degree angle to each other and said first face is connected to said second face.

In accordance with another embodiment, the present invention is a bag comprising a first face comprising polarizing material having a first polarizing axis and a second face comprising polarizing material having a second polarizing axis, wherein the angle between said first polarizing axis and said second polarizing axis is less than 90 degrees, and wherein said first face is connected to said second face.

In accordance with a further embodiment, the present invention is a bag comprising an inner container comprising polarizing material having a first polarizing axis and an outer container comprising polarizing material having a second polarizing axis, wherein when said inner container is receivable inside said outer container, said first polarizing axis and said second polarizing axis are at a 90 degree angle to each other.

In accordance with yet another embodiment, the present invention is a bag comprising a first face comprising a first polarizing means and a second face comprising a second polarizing means, wherein when said first polarizing means is juxtaposed against said second polarizing means, said juxtaposition prevents a light wave from passing through both said second polarizing means.

In accordance with a further embodiment, the present invention is a bag comprising an inner container comprising a first polarizing means and an outer container comprising a second polarizing means, wherein said inner container is receivable inside said outer container, and when said inner container is received inside said outer container, a light wave is prevented from passing through said inner container.

### BRIEF DESCRIPTION OF THE DRAWINGS

The foregoing and other objects, features, and advantages of the invention are apparent from the following detailed description taken in conjunction with the accompanying drawings in which like parts are given like reference numerals and, wherein:

FIG. 1 depicts an angled front view of a bag with a first face comprised of material having a first polarizing axis and a second face comprised of material having a second polarizing axis wherein said second polarizing axis is at a 90 degree angle from said first polarizing axis.

FIG. 2 depicts a back view of a bag wherein said second face is in a raised position.

FIG. 3 depicts an angled frontal view of a bag wherein said second face is in a raised position.

FIG. 4 depicts an angled front view of a bag wherein said second face is in a semi-raised position.

FIG. 5 depicts a front view a bag wherein said second face is in a lowered position.

FIG. 6 depicts a back view of a bag wherein said second face is in a lowered position.

FIG. 7 depicts an overhead view of a bag wherein said second face is in a lowered position.

FIG. 8 depicts a side view of a bag wherein said second face is in a lowered position.

FIG. 9 depicts a bottom view of a bag wherein said second face is in a lowered position.

FIG. 10 depicts an angled front view of a bag wherein said bag is comprised of an outer container having a first face comprised of material having a first polarizing axis and an inner container having a second face comprised of material having a second polarizing axis wherein said second polarizing axis is at a 90 degree angle from said first polarizing axis.

FIG. 11 depicts a front view of a bag wherein said bag is comprised of an outer container having a first face and an inner container having a second face.

FIG. 12 depicts a front view of a bag wherein exemplary contents are placed within said inner container.

FIG. 13 depicts a front view a bag wherein said inner container (comprising exemplary contents) is placed inside said outer container.

FIG. 14 depicts an angled front view of a second face of yet another embodiment of a bag.

FIG. 15 depicts a front view of a bag having a first face comprised of material having a first polarizing axis, and wherein exemplary contents are placed inside said bag.

FIG. 16 depicts a front view of a bag further comprising a second face comprised of material having a second polarizing axis wherein said second face is adjacent to said first face; and wherein said second polarizing axis is at a 0 degree (or 180 degree) angle to said first polarizing axis.

FIG. 17 depicts a front view of a bag wherein said second face is adjacent to said first face and said second face is rotated so that said second polarizing axis is at a 45 degree angle to said first polarizing axis.

FIG. 18 depicts a front view of a bag wherein said second face is adjacent to said first face and said second face is rotated so that said second polarizing axis is at a 90 degree angle to said first polarizing axis.

FIG. 19 depicts an angled frontal view of a bag wherein said second face is adjacent to said first face and said second face is rotated so that said second polarizing axis is at a 90 degree angle to said first polarizing axis.

FIG. 20 depicts a rear view of a bag wherein said second face is adjacent to said first face and said second face is rotated so that said second polarizing axis is at a 90 degree angle to said first polarizing axis.

FIG. 21 depicts light transmitted through a linear polarizer.

FIG. 22 depicts light transmitted through a first linear polarizer and a second linear polarizer wherein said polarizers are at a 90 degree angle to each other.

The images in the drawings are simplified for illustrative purposes and are not depicted to scale. Within the descriptions of the figures, similar elements are provided similar names and reference numerals as those of the previous figure(s). The specific numerals assigned to the elements are provided solely to aid in the description and are not meant to imply any limitations (structural or functional) on the invention.

The appended drawings illustrate exemplary configurations of the invention and, as such, should not be considered as limiting the scope of the invention that may admit to other equally effective configurations. It is contemplated that features of one configuration may be beneficially incorporated in other configurations without further recitation.

### DETAILED DESCRIPTION

The embodiments of the disclosure will be best understood by reference to the drawings, wherein like parts are designated by like numerals throughout. It will be readily understood that the components, as generally described and illustrated in the Figures herein, could be arranged and designed in a wide variety of different configurations or be entirely separate. Thus, the following more detailed description of the embodiments of the system and method of the disclosure, as represented in the Figures is not intended to limit the scope of the disclosure, as claimed, but is merely representative of possible embodiments of the disclosure.

The Polarizing Material Layers

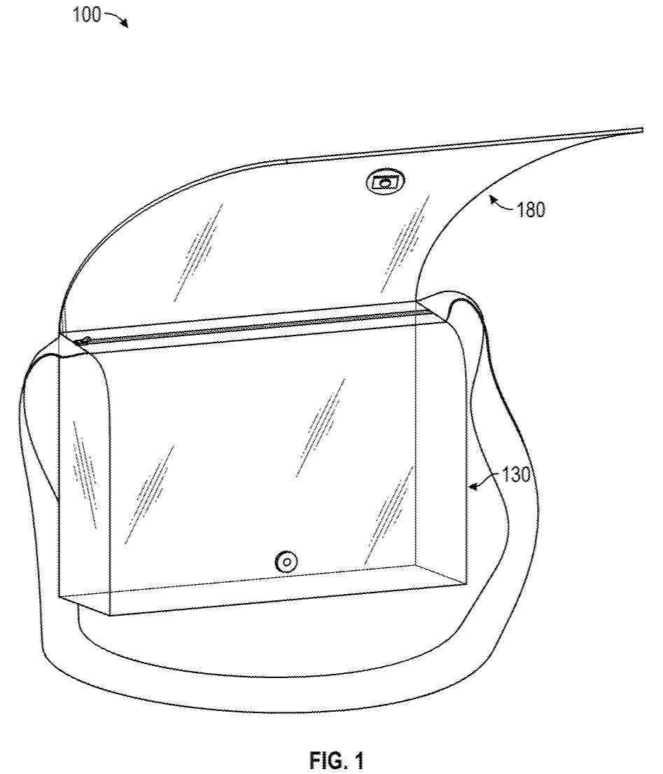

FIG. 1 depicts a front view of an embodiment of the present invention comprising a bag 100 with a first face 130 comprised of polarizing material having a first polarizing axis and a second face 180 (taking the form of a flap connected to said first face 130) comprised of polarizing material having a second polarizing axis wherein said second polarizing axis is at a 90 degree angle from the first polarizing axis. The polarizing material of an embodiment of the present invention may be polarizing plastic, film or other polarizing material, and may be PFLO60 Polarizing Film by United Scientific Supplies, Inc. The polarizing material may provide for varying degrees of transmission of light, and the other properties of the polarizing material may vary.

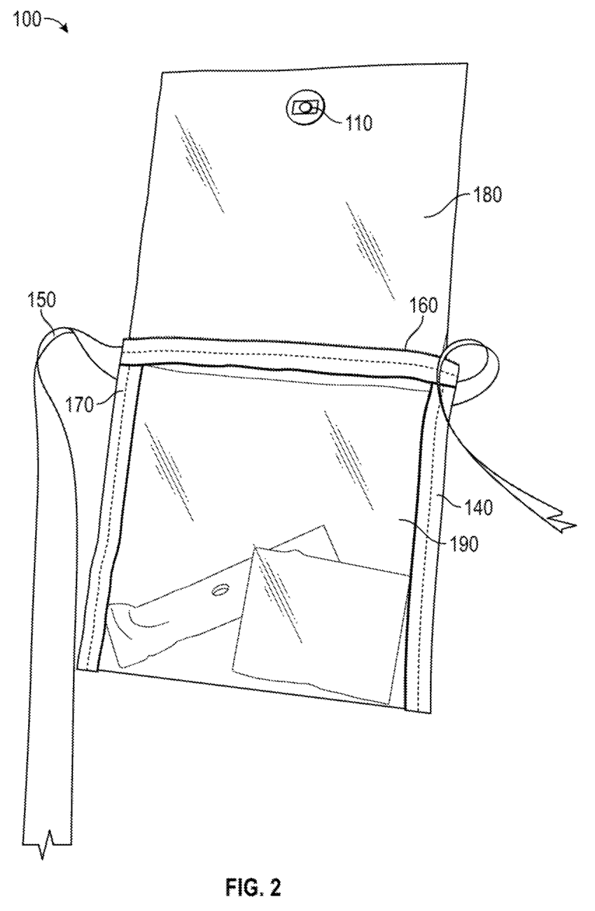

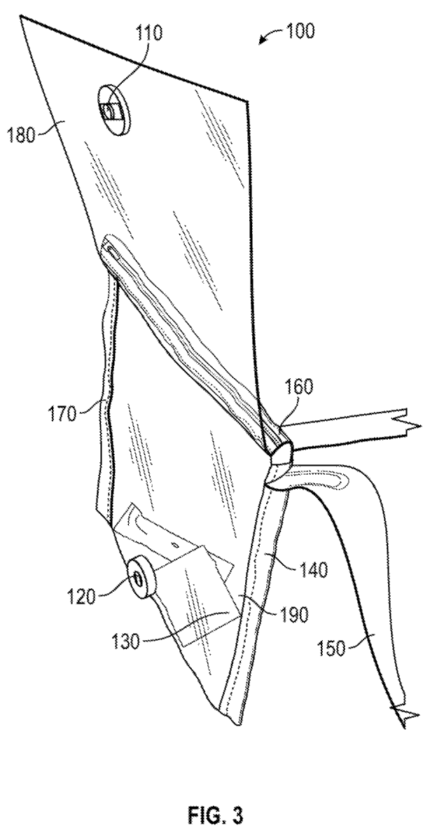

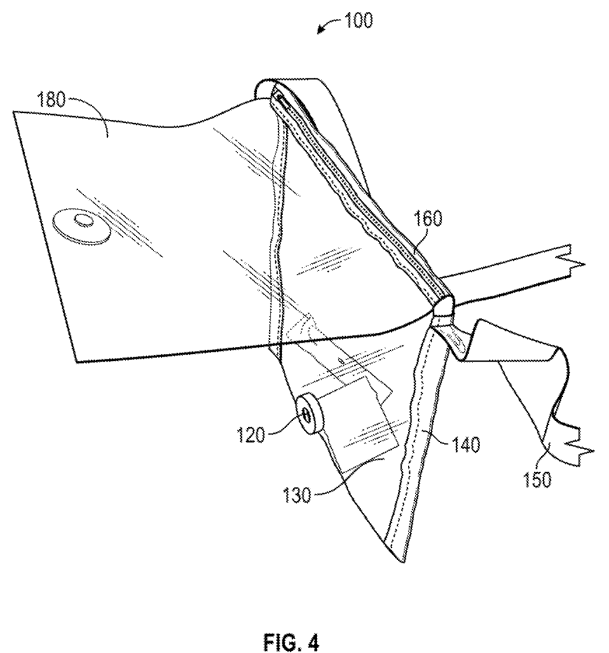

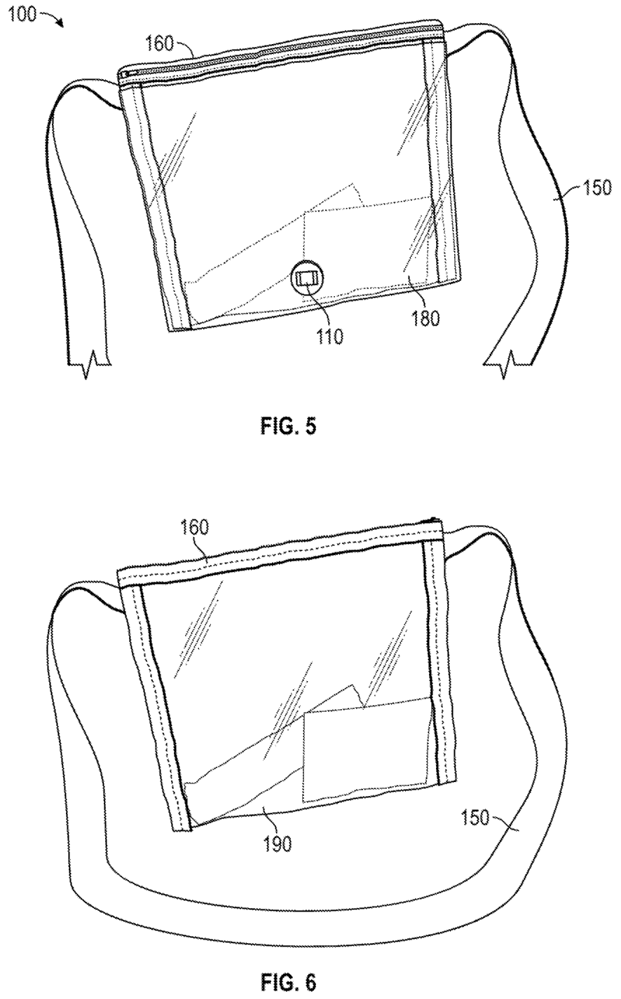

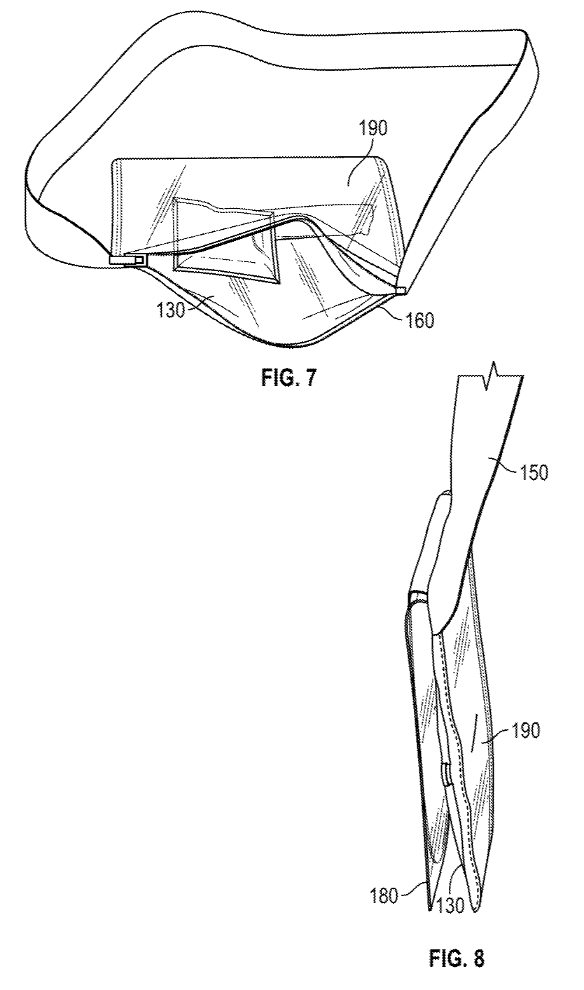

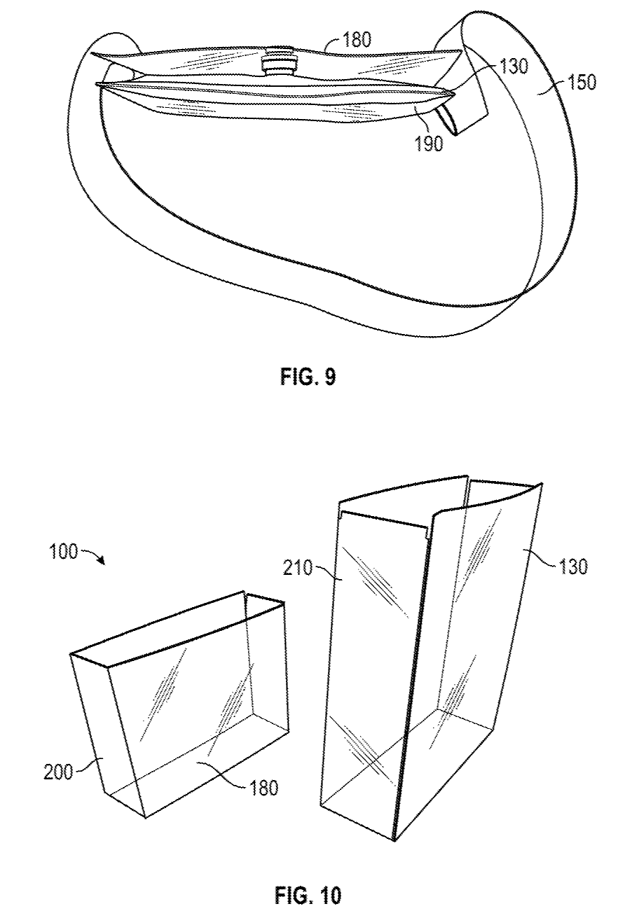

As shown in FIGS. 1 through 9, the second face 180 can be in a raised position (as shown in FIGS. 2 and 3), in a lowered position (as shown in FIGS. 5-9) or in an intermediary or semi-raised position (as shown in FIG. 4). When the second face 180 is in a lowered position, the second face 180 is adjacent to, and covers at least a portion of, the first face 130.

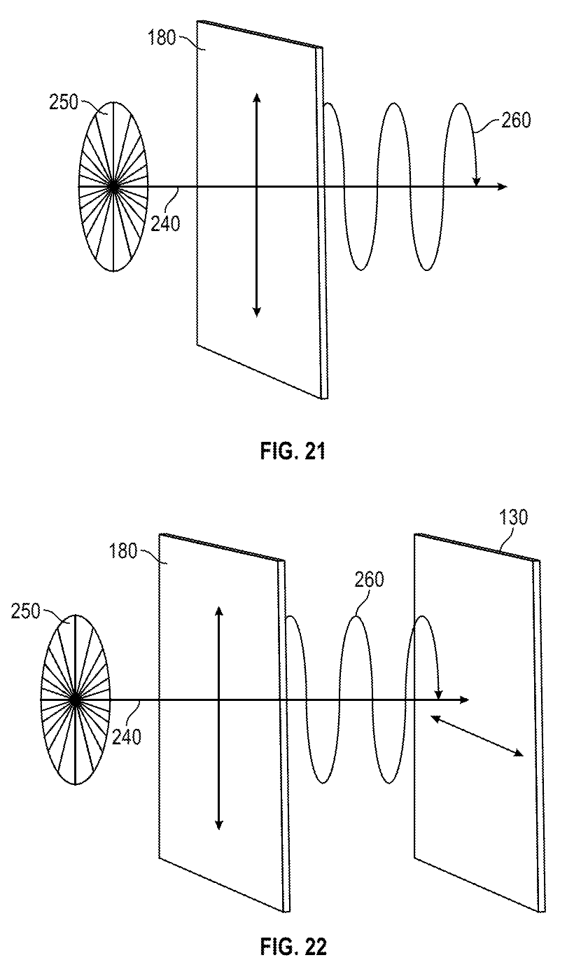

As shown in the embodiment of FIG. 5, when the second face 180 is in a lowered position, the second face 180 covering the first face 130 prevents light from passing completely through the adjacent second face 180 and first face 130 thereby preventing an observer to see behind the second face 180 and the first face 130 (compare the ability to see the contents (depicted with reduced weight lines) of the bag in FIGS. 3 and 4 to the inability to see the contents (depicted with broken lines) of the bag in FIG. 5). This phenomenon, referred to as extinction, is further depicted in FIGS. 21 and 22.

FIG. 21 depicts a polarizing material layer (for example, the second face 180) having a polarizing axis of 90 degrees. When light waves 240, from a light source 250, pass through the polarizing material layer, the light becomes linearly polarized light 260. Specifically, when the light waves 240 pass through the polarizing material layer (for example, the second face 180), only the light waves 240 oscillating in the same direction as the polarizing axis (e.g., vertically) pass through the polarizing material layer 180, as shown by linearly polarized light 260.

FIG. 22 also depicts an additional polarizing material layer (for example, the first face 130) having a polarizing axis 90 degrees to the polarizing axis of the second face 180. The additional polarizing material layer (for example, the first face 130) comprising a polarizing axis at 90 degrees from the polarizing axis of the second face 180 prevents the linearly polarized light 260 oscillating vertically from passing through the second polarizing material layer having a polarizing axis 90 degrees to the oscillations of the linearly polarized light 260. As such, none of the linearly polarized light waves 260 pass through the first face 130, thereby preventing anyone from viewing through an adjacent first face 130 and second face 180.

The Bag—Exemplary Configurations

FIGS. 1 through 20 show various embodiments of the bag of the present invention. However, this invention can be used for other items, including, but not limited to, purses, backpacks, suitcases, luggage, diaper bags, computer bags, tablet cases, document folders, camera bags, binocular cases, or any item carrying container.

As shown in FIGS. 2-9, in one embodiment, the bag 100 of the present invention comprises a first face 130 and a rear face 190 wherein said first face 130 and said rear face 190 are parallel or substantially parallel. The first face 130 and rear face 190 are connected by edging 170, 140. Additionally, the top edges of the first face 130 and the rear face 190 are connected via a zipper 160.

The embodiment of FIGS. 2-9 further includes a second face 180 (taking the form of a flap) that is connected at its top edge to the first face 130. When in a lowered position, the second face 180 is adjacent to, and at least partially covers, the first face 130. The bag 100 may optionally include a clasp 110,120 that secures the second face 180 to the first face 130 in a lowered position. The bag 100 may also comprise a strap 150.

In embodiments of the present invention, the first face 130 is comprised of polarizing material having a first polarizing axis (other portions of the bag may or may not comprise polarizing material) and the second face 180 is at least partially comprised of polarizing material having a second polarizing axis wherein said second polarizing axis is at a 90 degree angle to the first polarizing axis. Because of the two different polarizing axes, when the second face 180 is in the lowered position, a person cannot see through the overlapping portions of the first face 130 and the second face 180 (compare the ability to see the contents (depicted with reduced weight lines) in FIG. 3 wherein the second face 180 is in the raised position to the inability to see the contents (depicted with broken lines) in FIG. 5 wherein the second face 180 is in the lowered position).

As shown in FIGS. 5 and 6, when the second face 180 is in the lowered position, a person cannot see through the front of the bag 100 but can still see through the rear face 190. However, other embodiments of the present invention may optionally include a rear face comprising a material layer having a polarizing axis and a back flap comprising a second polarizing material layer (the second polarizing material layer having a polarizing axis 90 degrees to that of the polarizing axis of the back face) attached to the second face 190. When said back flap is in the lowered position, a person would not be able to see the contents of the bag through the rear of the bag 100. Other embodiments of the present invention may comprise additional flaps comprising polarizing material for sides, tops, bottoms, etc. of the purse, and wherein all of the bag, or a portion of the bag, is made of a first polarizing material layer.

In alternative embodiments, the angle between the polarizing axis of the first polarizing material layer and the polarizing axis of the second polarizing material layer is an angle other than 90 degrees, thereby providing decreased transparency but not complete opacity. Further, in other embodiments (not shown), the bag 100 may take another configuration than the one shown in the figures. The bag, 100, first face 130 and second face 180 may be of any shape or size.

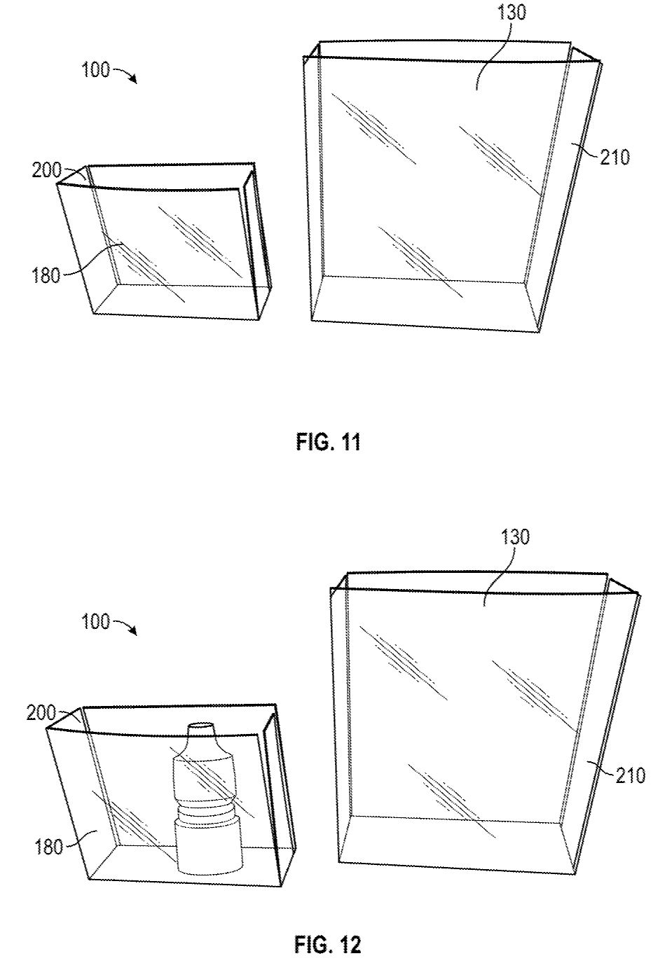

FIGS. 10-13 depict another exemplary embodiment of the present invention. As shown in FIGS. 10-11, in this embodiment the bag 100 comprises an inner container 200 comprising a second face 180 and an outer container 210 comprising a first face 130, wherein the inner container 200 can be placed inside the outer container 210. The inner container 200 and the outer container 210 may be of any shape or size so long as the inner container 200 can at least partially fit inside said outer container 210.

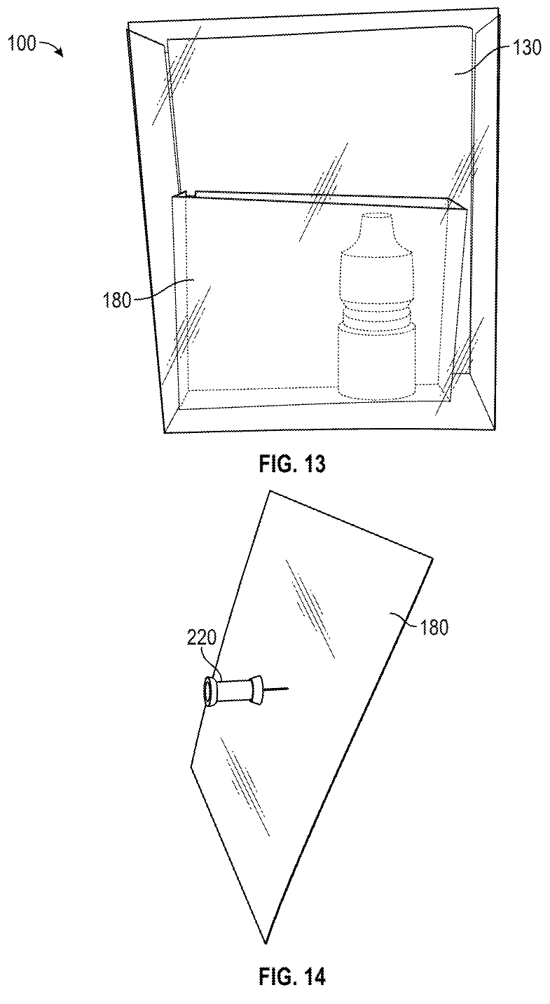

The first face 130 comprises polarizing material having a first polarizing axis and the second face 180 comprises polarizing material having a second polarizing axis wherein said second polarizing axis is at a 90 degree angle to the first polarizing axis. As shown in FIG. 12, when contents (depicted with reduced weight lines) are placed inside the inner container 200 (and the inner container 200 is not inside the outer container 210), the contents can be viewed through the second face 180 of the inner container 200. However, as shown in FIG. 13, when the inner container 200 is placed inside the outer container 210, the contents (depicted with broken lines) cannot be seen through the first face 130 and second face 180.

FIGS. 14-20 depict yet another exemplary embodiment of the present invention. As shown in FIGS. 14-16, this embodiment comprises a container 230 (having a first face 130) and a rotatable second face 180 adjacent to said first face 130. The first face 130 comprises polarizing material having a first polarizing axis and the second face 180 comprises polarizing material having a second polarizing axis. This embodiment further includes an attachment piece 220 that allows the second face 180 to be connected to the first face 130 and rotated.

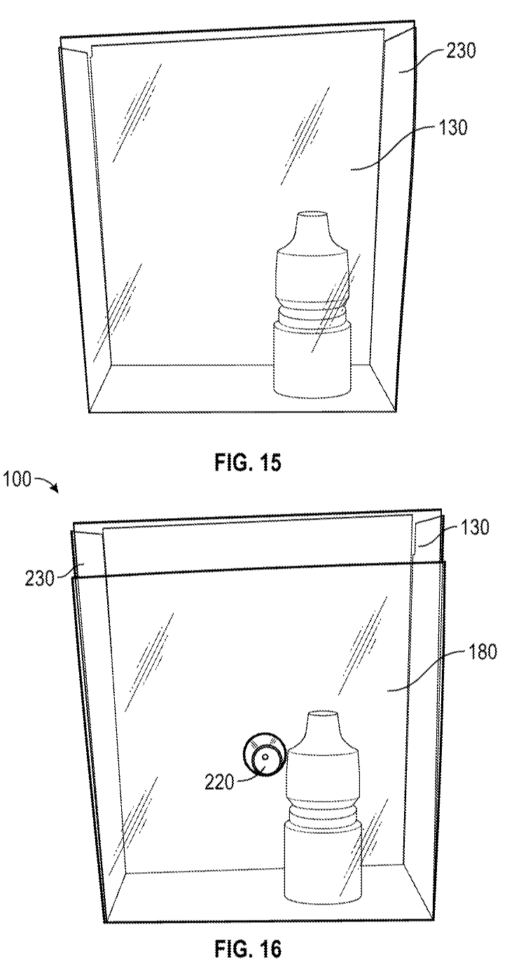

As shown in FIG. 15, when contents (depicted with reduced weight lines) are placed inside the container 230, the contents can be viewed through the first face 130. Additionally, as shown in FIG. 16, when the second face 180 is connected to the first face 130, via the attachment piece 220, and the first polarizing axis is at a 0 or 180 degree angle to the second polarizing axis, the contents (depicted with reduced weight lines) can be viewed through the second face 180 and first face 130.

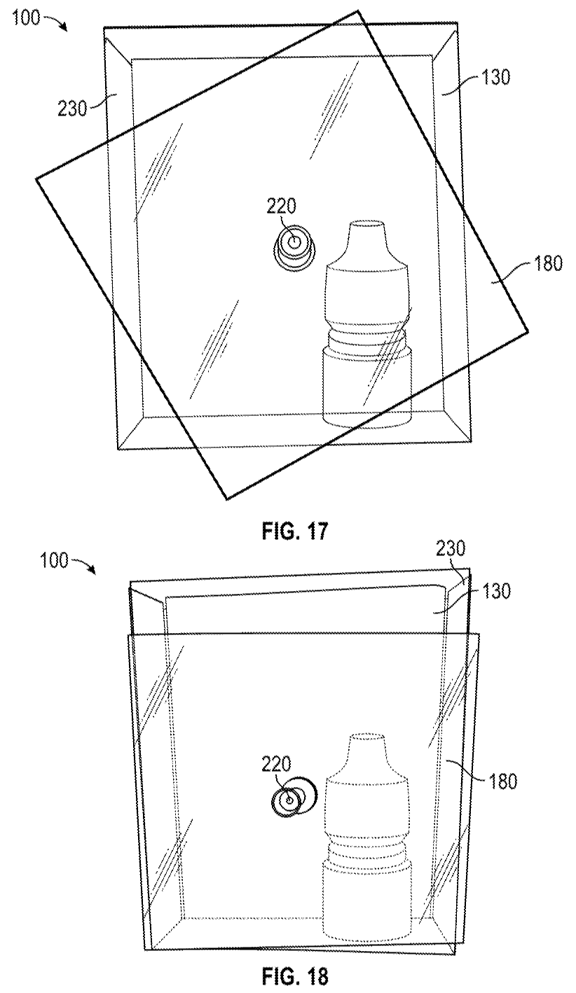

As shown in FIG. 17, when the second face 180 is rotated 45 degrees (so that the second polarizing axis is at a 45 degree angle to the first polarizing axis), the contents (depicted with reduced weight lines) can still be viewed, but with reduced transparency, through the second face 180 and first face 130.

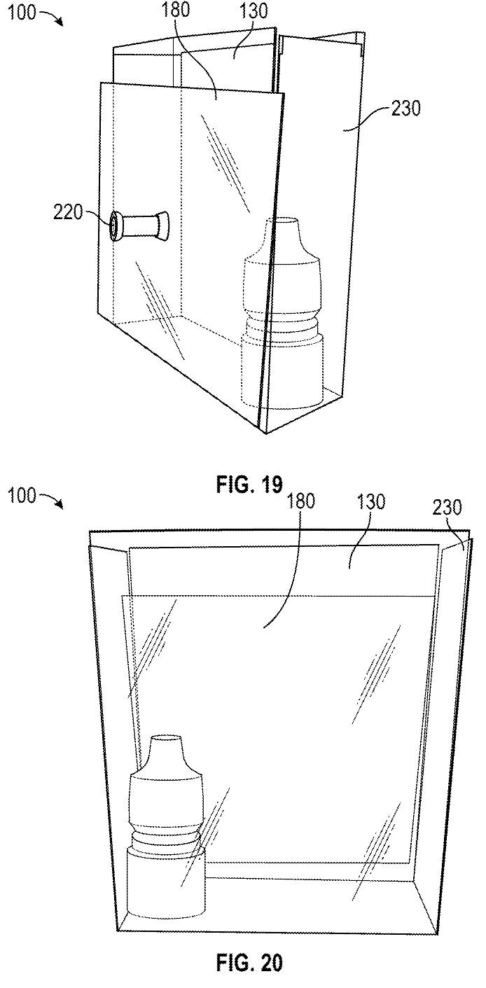

However, as shown in FIGS. 18 and 19, when the second face 180, is rotated 90 degrees (so that the second polarizing axis is at a 90 degree angle to the first polarizing axis), the contents (depicted with broken lines) cannot be viewed through the second face 180 and first face 130. FIG. 20 depicts a rear view of this embodiment wherein the contents may be viewed through the rear of the bag 100 but one cannot view through the second face 180 and first face 130.

In other embodiments (not shown), the bag 100 may take another configuration than the one shown in the figures. The bag 100, container 230, first face 130 and second face 180 may be of any shape or size.

What is claimed is:

1. A bag comprising:
a first face comprising polarizing material having a first polarizing axis; and
a second face comprising polarizing material having a second polarizing axis, wherein said first polarizing axis and said second polarizing axis are at a 90 degree angle to each other, and wherein said first face is connected to said second face.

2. The bag of claim 1 wherein said second face comprises a flap.

3. The bag of claim 2 wherein said first face comprises an upper edge and said flap is connected to said first face at said upper edge.

4. The bag of claim 1 further comprising an attachment piece wherein said second face is connected to said first face by said attachment piece.

5. The bag of claim 4 wherein said second face is rotatable about said attachment piece.

6. A bag comprising:
a first face comprising polarizing material having a first polarizing axis; and
a second face comprising polarizing material having a second polarizing axis, wherein the angle between said first polarizing axis and said second polarizing axis is less than 90 degrees, and wherein said first face is connected to said second face.

7. The bag of claim 6 wherein said second face comprises a flap.

8. The bag of claim 7 wherein said first face comprises an upper edge and said flap is connected to said first face at said upper edge.

9. The bag of claim 6 further comprising an attachment piece wherein said second face is connected to said first face by said attachment piece.

10. The bag of claim 9 wherein said second face is rotatable about said attachment piece.

11. A bag comprising:
an inner container comprising polarizing material having a first polarizing axis; and
an outer container comprising polarizing material having a second polarizing axis;
wherein when said inner container is receivable inside said outer container, said first polarizing axis and said second polarizing axis are at a 90 degree angle to each other.

12. The bag of claim 11 wherein said inner container is fully receivable inside said outer container.

13. The bag of claim 11 wherein said inner container is partially receivable inside said outer container.

14. A bag comprising:
a first face comprising a first polarizing means; and
a second face comprising a second polarizing means; wherein when said first polarizing means is juxtaposed against said second polarizing means, said juxtaposition prevents a light wave from passing through both said second polarizing means.

15. The bag of claim 14 wherein said first polarizing means and said second polarizing means are at a 90 degree angle to each other.

16. A bag comprising:
an inner container comprising a first polarizing means; and
an outer container comprising a second polarizing means; wherein said inner container is receivable inside said outer container, and when said inner container is received inside said outer container, a light wave is prevented from passing through said inner container.

17. The bag of claim 16 wherein said first polarizing means and said second polarizing means are at a 90 degree angle to each other.
